(19) United States
(12) Patent Application Publication
(10) Pub. No.: US 2008/0109136 A1
(43) Pub. Date: May 8, 2008

(54) Adjustable crash trigger apparatus and method thereof

(76) Inventors: Jen-Chi Liao, Sinjhuang City (TW); Chuen-Lin Bau, Longtan Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/591,596

(22) Filed: Nov. 2, 2006

(51) Int. Cl. B60R 21/00

(52) U.S. Cl. 701/45; 280/735; 180/282

(57) ABSTRACT

The present invention relates to an adjustable crash trigger apparatus and a method thereof. The adjustable crash trigger apparatus according to the present invention includes a power supply module, an electronic accelerometer module, and a microcontroller module, which includes at least a real-time processing unit and a beacon-activated command unit. The apparatus and the method thereof are used to judge if a vehicle satisfies is about to collide. When it is judged true, an emergency transmitting device is activated, and the vehicle is located. In addition, the apparatus according to the present invention is electronic type and can judge three axes. The threshold acceleration value is adjusted depending on the type of the vehicle. Thereby, high sensitivity, low false alarm rate, and low failure rate can be achieved.

### FIELD OF THE INVENTION

The present invention relates generally to a crashcrash trigger apparatus and a method thereof, and particularly to an adjustable crashcrash trigger apparatus and a method thereof using electronics and directions in three axes to judge if a vehicle satisfies crash criteria or not, applicable to marine, ground, and flight vehicles.

### BACKGROUND OF THE INVENTION

Current crashcrash trigger apparatuses are applied in air bags, and are triggered mechanically. When the crashcrash trigger apparatuses are used in automobiles, the acceleration values in directions of three axes do not exceed 1 G. The acceleration values produced at the moments of high-speed crashs are at most between 1 G and 2 G only. In addition, general crash trigger apparatuses usually judge crash trigger by, at most, directions in two axes. Thereby, such crash trigger apparatuses are only suitable for general applications, not applicable to crash trigger scenarios in various flight vehicles. If current crash trigger apparatuses are applied to flight vehicles, it usually causes false alarm or failure, needless to say applications in fighter planes.

The technology as described above in the prior art can judge crash trigger in general vehicles, however, it is not feasible for flight vehicles. The crash trigger apparatuses are mechanical, and can perform two-axis judgments only. Besides, the threshold acceleration value cannot be adjusted. Thereby, the technology in the prior art cannot meet the needs of some applications.

### SUMMARY

The purpose of the present invention is to provide an adjustable crash trigger apparatus and a method thereof applicable to marine, ground, and flight vehicles. In addition, judgment is made in direction of three axes. The threshold acceleration values are adjustable for achieving high sensitivity, low false alarm rate, and low failure rate.

In order to achieve the purpose described above, the adjustable crash trigger apparatus according to the present invention includes a power supply module, an electronic accelerometer module, and a microcontroller module connected with the power supply module and the electronic accelerometer module. The microcontroller module includes at least a real-time processing unit and a beacon-activated command unit.

The adjustable crash trigger method first measure the acceleration value of a vehicle in the direction of at least one axis. Then judge if the vehicle satisfies the crash criterion. If it does, transmit a trigger alarm signal to an emergency transmitting device and locate the vehicle.

The method of judging if the vehicle satisfies the crash criterion includes first extracting acceleration values in the directions of at least one axis, calculating the resultant acceleration value, judging if the resultant acceleration value exceeds a threshold acceleration value, calculating the resultant velocity variation if the resultant acceleration value exceeds a threshold acceleration value, then judging if the resultant velocity variation exceeds a minimum velocity variation, and if the resultant velocity variation exceeds a minimum velocity variation, which means the crash criterion is satisfied, transmitting a trigger alarm signal.

### BRIEF DESCRIPTION OF THE DRAWINGS

FIG. 1 shows a structural schematic diagram of the adjustable crash trigger apparatus according to a preferred embodiment of the present invention;

FIG. 2 shows a structural schematic diagram of the adjustable crash trigger apparatus according to another preferred embodiment of the present invention;

FIG. 3A shows a flowchart of the adjustable crash trigger method according to a preferred embodiment of the present invention;

FIG. 3B shows a flowchart of judging if the crash criterion has been satisfied according to a preferred embodiment of the present invention;

FIG. 4 shows crash response curves of the adjustable crash trigger apparatus according to a preferred embodiment of the present invention;

FIG. 5 shows the relationship between velocity and time of the adjustable crash trigger apparatus according to a preferred embodiment of the present invention;

FIG. 6A shows an acceleration curve in the x-axis of the adjustable crash trigger apparatus according to a preferred embodiment of the present invention;

FIG. 6B shows an acceleration curve in the y-axis of the adjustable crash trigger apparatus according to a preferred embodiment of the present invention;

FIG. 6C shows an acceleration curve in the z-axis of the adjustable crash trigger apparatus according to a preferred embodiment of the present invention; and

FIG. 7 shows a resultant acceleration curve of the adjustable crash trigger apparatus according to a preferred embodiment of the present invention.

### DETAILED DESCRIPTION

In order to make the structure and characteristics as well as the effectiveness of the present invention to be further understood and recognized, the detailed description of the present invention is provided as follows along with preferred embodiments and accompanying figures.

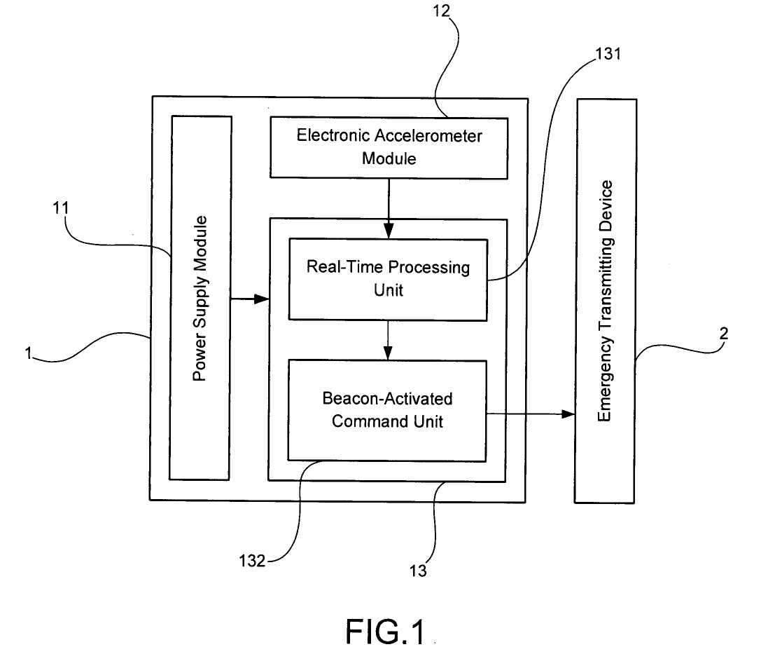

FIG. 1 shows a structural schematic diagram of the adjustable crash trigger apparatus according to a preferred embodiment of the present invention. As shown in the figure, the present invention relates to an adjustable crash trigger apparatus and a method thereof. The adjustable crash trigger apparatus 1 includes a power supply module 11, an electronic accelerometer module 12, and a microcontroller module 13 connected with the power supply module 11 and the electronic accelerometer module 12. The microcontroller module 13 includes at least a real-time processing unit 131 and a beacon-activated command unit 132.

The adjustable crash trigger apparatus 1 according to the present invention first uses the electronic accelerometer module 12 to measure the acceleration values in each axis (x-, y-, and z-axis) of a vehicle. Then the acceleration values of each axis are transmitted to the real-time processing unit 131 of the microcontroller module 13.

The real-time processing unit 131 can preset a threshold acceleration value and a minimum velocity variation. The threshold acceleration value is determined depending on the type of the vehicle. If the vehicle is a ground vehicle, such as an automobile, the threshold acceleration value can be set between 0.5 G and 2 G; if the vehicle is a flight vehicle, such as an airplane or a fighter plane, the threshold acceleration value can be set between 2 G and 3 G. Besides, the threshold acceleration value can be adjusted by adjusting the real-time processing unit 131 through a computer program.

The real-time processing unit 131 can judge if the vehicle satisfies the crash criterion. The time the real-time processing unit 131 judges if the vehicle satisfies the crash criterion is between 1 ms and 50 ms. The judgment method is that first receive the acceleration values in the directions of at least one axis of the vehicle measured by the electronic accelerometer module 12. If only single axis judgment is to be made, the acceleration value measured by the electronic accelerometer module 12 is compared with the threshold acceleration value. When the acceleration value is greater than the threshold acceleration value, judge if the velocity variation of the vehicle is greater than the minimum velocity variation or not. If the velocity variation is greater than the minimum velocity variation, then activate the beacon-activated command unit 132.

The adjustable crash trigger apparatus 1 according to the present invention can judge in three axes, thereby the real-time processing unit 131 receives the acceleration values in each axis measured by the electronic accelerometer module 12. However, the acceleration values have to be synthesized first to be a resultant acceleration value. Then, the resultant acceleration value is compared with the threshold acceleration value. When the resultant acceleration value is greater than the threshold acceleration value, judge if the resultant velocity variation of the vehicle is greater than the minimum velocity variation or not, wherein the resultant velocity variation is synthesized by the velocity variations in the three axes. If the resultant velocity variation is greater than the minimum velocity variation, then activate the beacon-activated command unit 132.

When the real-time processing unit 131 judges the vehicle is about to collide, the beacon-activated command unit 132 is activated. The beacon-activated command unit 132 can transmit a trigger alarm signal to an emergency transmitting device 2, which can be an Emergency Locator Transmitter (ELT).

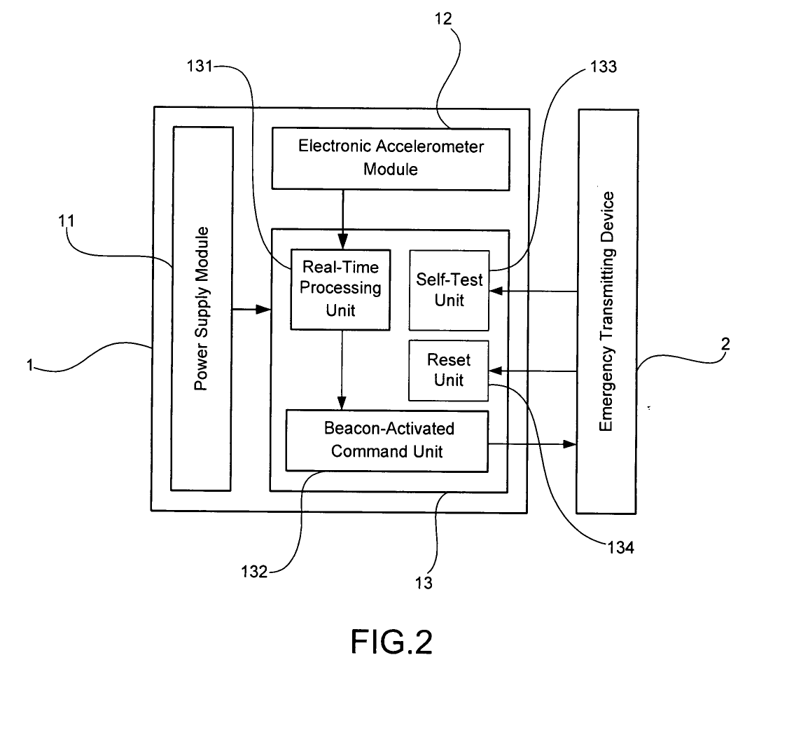

FIG. 2 shows a structural schematic diagram of the adjustable crash trigger apparatus according to another preferred embodiment of the present invention. As shown in the figure, the present invention relates to an adjustable crash trigger apparatus and a method thereof. The adjustable crash trigger apparatus according to the present preferred embodiment includes at least a power supply module 11, an electronic accelerometer module 12, and a microcontroller module 13 including a real-time processing unit 131 and a beacon-activated command unit 132. However, in order to prevent danger to users due to failure in the adjustable crash trigger apparatus 1, a self-test unit 133 and a reset unit 134 are adapted additionally in the microcontroller module 13.

The self-test unit 133 receives a signal of an emergency transmitting device 2 for performing self-tests. The self-tests include internal transmission and external transmission tests in the adjustable crash trigger apparatus 1 for judging if the adjustable crash trigger apparatus 1 operates normally. Each time when the self-tests are performed, the beacon-activated command unit 132 is activated. The beacon-activated command unit 132 will transmit a trigger alarm signal to the emergency transmitting device 2. At this moment, the beacon-activated command unit 132 is in logic 1, thereby a reset has to be performed. The reset action is performed by the reset unit 134 when it receives the signal transmitted by the emergency transmitting device 2.

When the self-test unit 133 is performing self-tests, if a failure occurred, the self-test unit 133 would transmit an alarm signal, which can be a sound or a light.

The power supply module 11 according to the present preferred embodiment is a rechargeable battery (lithium battery). The power supply module 11 connects with the microcontroller module 13, which connects with the electronic accelerometer module 11. The electronic accelerometer module 11 measures the acceleration values in at least one axis of the vehicle, and transmits them to the real-time processing unit 131 of the microcontroller module 13 for judging if the vehicle is about to collide. Of the vehicle is judged to be about to collide, then the beacon-activated command unit 132 is activated and transmits a trigger alarm signal to the emergency transmitting device 2.

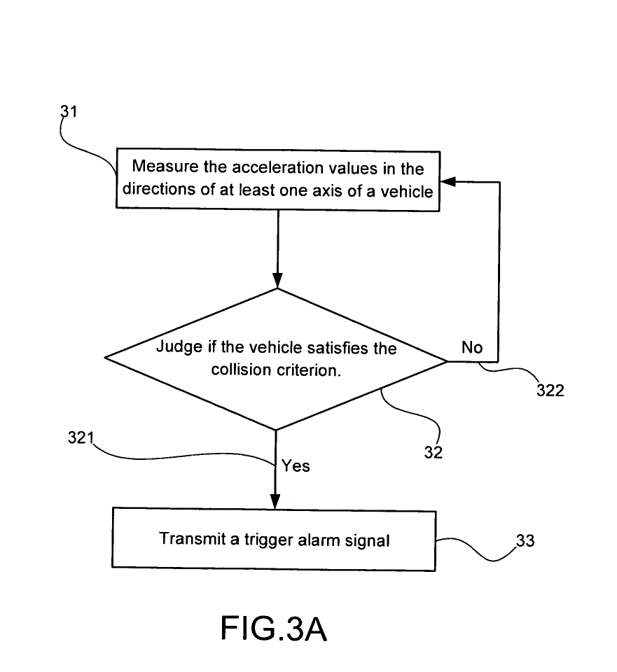

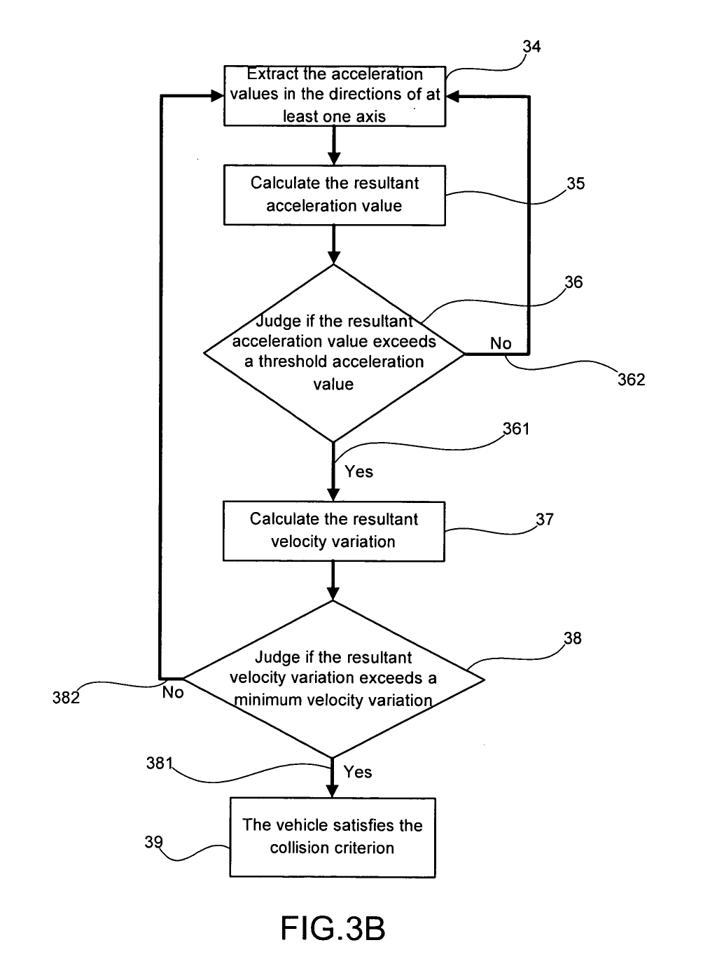

FIG. 3A shows a flowchart of the adjustable crash trigger method according to a preferred embodiment of the present invention. FIG. 3B shows a flowchart of judging if the crash criterion has been satisfied according to a preferred embodiment of the present invention. As shown in the figures, the present invention relates to an adjustable crash trigger method includes the following steps:

Step 31: Measure the acceleration values in the directions of at least one axis of a vehicle.

Step 32: Judge if the vehicle satisfies the crash criterion.

Step 321: When the vehicle satisfies the crash criterion, proceed to the step 33.

Step 322: When the vehicle does not satisfy the crash criterion, return to the step 31.

Step 33: Transmit a trigger alarm signal.

The method of judging if the crash criterion has been satisfied described above includes the following steps:

Step 34: Extract the acceleration values in the directions of at least one axis of a vehicle.

Step 35: Calculate the resultant acceleration value. If only the acceleration value of one axis (x-, y-, or z-axis) is extracted in the step 34, said acceleration value is the resultant acceleration value. On the other hand, if the acceleration values of three axes (x-, y-, and z-axis) are extracted in the step 34, the resultant acceleration value is the square root of the sum of each of the acceleration values in respective axis squared.

Step 36: Judge if the resultant acceleration value exceeds a threshold acceleration value, which is determined depending on the type of the vehicle.

Step 361: When the resultant acceleration value exceeds the threshold acceleration value, proceed to the step 37.

Step 362: When the resultant acceleration value is smaller than the threshold acceleration value, return to the step 37.

Step 37: Calculate the resultant velocity variation. If only the velocity variation of one axis (x-, y-, or z-axis) is extracted, said velocity variation is the resultant velocity variation. On the other hand, if the velocity variations of three axes (x-, y-, and z-axis) are extracted, the resultant velocity variation is the square root of the sum of each of the velocity variations in respective axis squared.

Step 38: Judge if the resultant velocity variation exceeds a minimum velocity variation.

Step 381: When the resultant velocity variation exceeds the minimum velocity variation, proceed to the step 39.

Step 382: When the resultant velocity variation is smaller than the minimum velocity variation, return to the step 34.

Step 39: The vehicle satisfies the crash criterion.

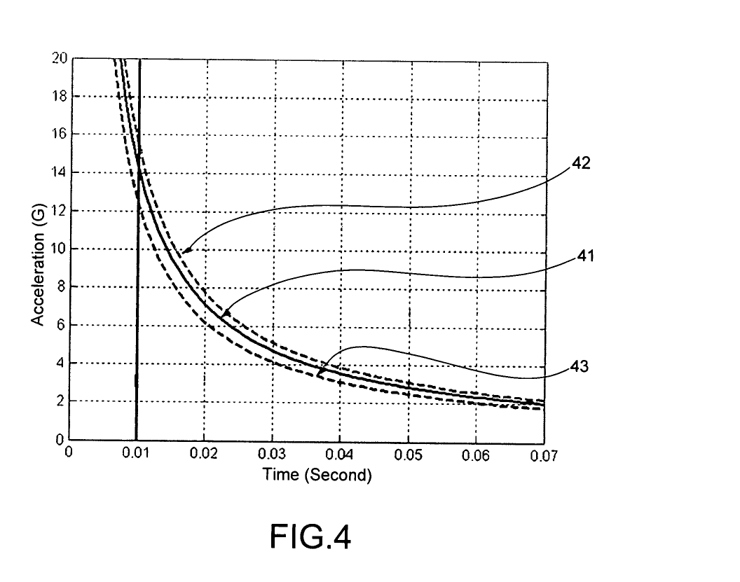

FIG. 4 shows crash response curves of the adjustable crash trigger apparatus according to a preferred embodiment of the present invention. As shown in the figure, the curves include a baseline curve 41, a first curve 42, and a second curve 43. By the baseline curve 41, it is known that the threshold acceleration value is approximately 14 G, while the minimum velocity variation is 1.4 m/s.

A first initial acceleration value of the first curve 42 is greater than 14 G, and a first velocity variation is 1.52 m/s. Thereby, the first initial acceleration value exceeds the threshold acceleration value of the baseline curve 41, and the first velocity variation also exceeds the minimum velocity variation. Accordingly, under such a condition, the adjustable crash trigger apparatus 1 transmits a trigger alarm signal to an emergency transmitting device 2.

A second initial acceleration value of the second curve 43 is smaller than 14 G; and a second velocity variation is 1.22 m/s. Thereby, the second initial acceleration value is smaller than the threshold acceleration value of the baseline curve 41, and the second velocity variation is also smaller than the minimum velocity variation. Accordingly, under such a condition, the adjustable crash trigger apparatus 1 will not activate the emergency transmitting device 2.

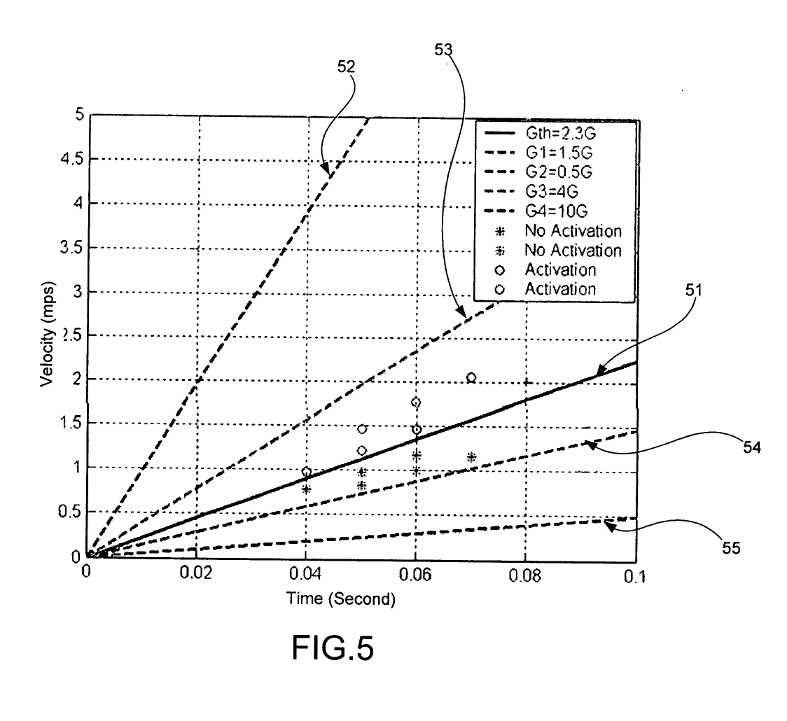

FIG. 5 shows the relationship between velocity and time of the adjustable crash trigger apparatus according to a preferred embodiment of the present invention. As shown in the figure, the curves include a first relationship curve 51, a second relationship curve 52, a third relationship curve 53, a fourth relationship curve 54, and a fifth relationship curve 55. The first relationship cure 51 is used as the baseline, by which the threshold acceleration value is known to be 2.3 G. Then, the acceleration values of the second and the third relationship curves 52, 53 are 10 G and 4 G, respectively, which both exceed the threshold acceleration value. The acceleration values of the fourth and the fifth relationship curves 54, 55 are 1.5 G and 0.5 G, respectively, which are both smaller than the threshold acceleration value. In addition, by slopes of the curves, it is known that the velocity variation of the second relationship curve is the greatest, while the velocity variation of the fifth relationship curve is the smallest. Accordingly, the adjustable crash trigger apparatus 1 will activate the emergency transmitting device 2 under the conditions of the second and the third relationship curves 52, 53. On the contrary, the adjustable crash trigger apparatus 1 need not to activate the emergency transmitting device 2 under the conditions of the fourth and the fifth relationship curves 54, 55.

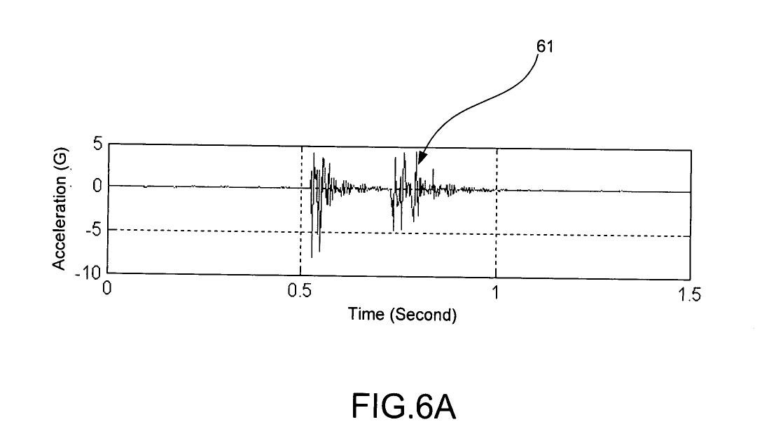

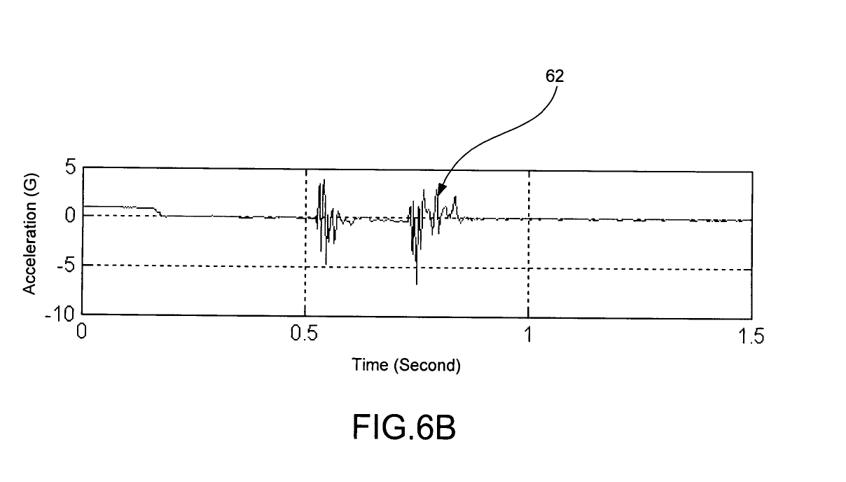

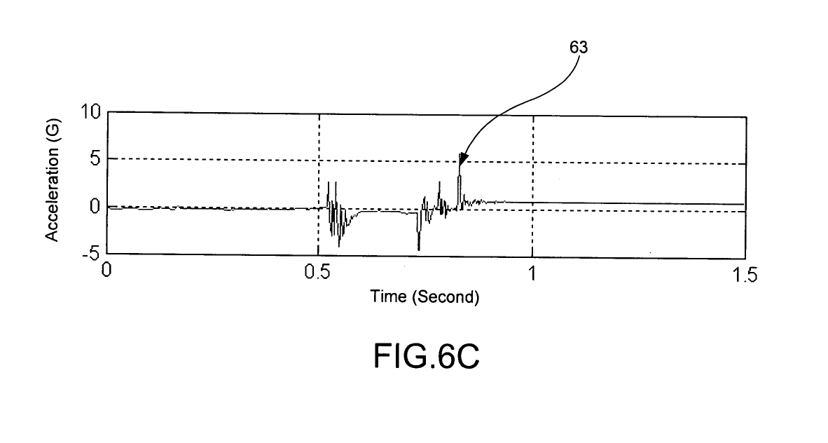

FIGS. 6A, 6B, and 6C show acceleration curves in the x-, y-, and z-axis of the adjustable crash trigger apparatus according to a preferred embodiment of the present invention, respectively. As shown in the figures, the crash trigger apparatus according to the present invention is taken to a drop test. The curves described above include an x-axis acceleration curve 61, a y-axis acceleration curve 62, and a z-axis acceleration curve 63. It is known by the acceleration curves that when the crash trigger apparatus is at rest, it only produces an acceleration value of 1 G in the y-axis. It is because the y-axis of the adjustable crash trigger apparatus faces to the ground, thereby the resultant acceleration value is 1 G. When the adjustable crash trigger apparatus is dropped, no acceleration value is detected in all three axes. Then, when the adjustable crash trigger apparatus falls and collides with the ground, each of the axes extracts acceleration values, and it is known that two major acceleration changes occurred, which includes the crash when the adjustable crash trigger apparatus first touches the ground, and the overturn crash after the apparatus touches the ground, respectively. Then, the adjustable crash trigger apparatus recover to rest. It is known by the z-axis acceleration curve 63 that the adjustable crash trigger apparatus experiences an acceleration value of 1 G in the z-axis when it recovers to rest. It is because that the z-axis of the adjustable crash trigger apparatus faces to the ground after turning 90 degrees caused by the crashs.

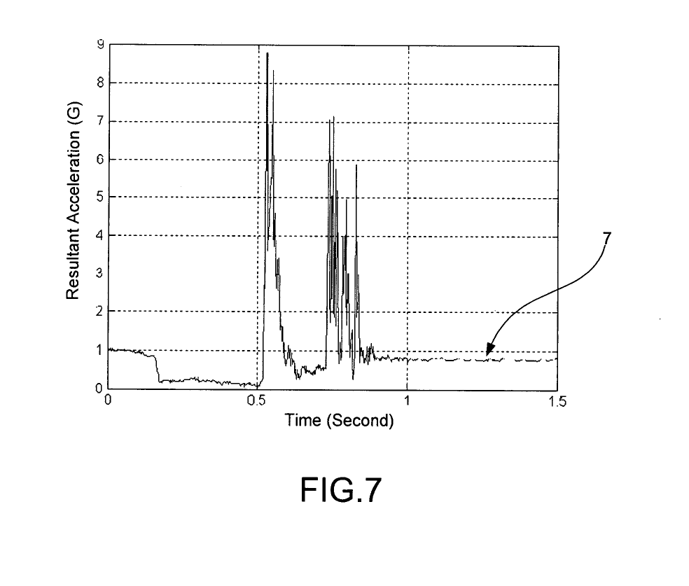

FIG. 7 shows a resultant acceleration curve of the adjustable crash trigger apparatus according to a preferred embodiment of the present invention. As described above, the adjustable crash trigger apparatus according to the present invention is taken to a drop test. The acceleration change in each of the axes after the drop test is described. In order to judge if the crash criterion has been satisfied or not, the acceleration values in the axes have to be synthesized to be a resultant acceleration value. As shown in the figure, the acceleration values in the axes are synthesized to be a resultant acceleration curve 7. By the resultant acceleration curve 7, it is known that the duration of first peak crash is approximately 0.03 seconds. In addition, the duration of acceleration values exceeding 2 G is also approximately 0.03 seconds.

To sum up, the adjustable crash trigger apparatus and the method thereof according to the present invention can improve effectively the various drawbacks in the prior art. It can be applied in marine, ground, and flight vehicles. Besides, the apparatus according to the present invention is electronic type and can judge three axes. The threshold acceleration value is adjusted depending on the type of the vehicle. Thereby, high sensitivity, low false alarm rate, and low failure rate can be achieved.

Accordingly, the present invention conforms to the legal requirements owing to its novelty, unobviousness, and utility. However, the foregoing description is only a preferred embodiment of the present invention, not used to limit the scope and range of the present invention. Those equivalent changes or modifications made according to the shape, structure, feature, or spirit described in the claims of the present invention are included in the appended claims of the present invention.

1. An adjustable crash trigger apparatus, comprising:
a power supply module, providing power;
an electronic accelerometer module, measuring acceleration values in the directions of at least one axis of a vehicle; and
a microcontroller module, connecting with the power supply module and the electronic accelerometer module, comprising at least:
a real-time processing unit, receiving the acceleration values in the directions of at least one axis measured by the electronic accelerometer module for judging if the vehicle satisfies the crash criterion, and transmitting a driving signal; and
a beacon-activated command unit, receiving the driving signal transmitted by the real-time processing unit, and transmitting a trigger alarm signal.

2. The adjustable crash trigger apparatus of claim 1, wherein the time the real-time processing unit judges if the vehicle satisfies the crash criterion if between 1 ms and 50 ms.

3. The adjustable crash trigger apparatus of claim 1, wherein the real-time processing unit presets a threshold acceleration value and a minimum velocity variation for judging if the crash criterion has been satisfied.

4. The adjustable crash trigger apparatus of claim 3, wherein the threshold acceleration value is adjusted depending on the type of the vehicle, and is adjusted by adjusting the real-time processing unit through a computer program.

5. The adjustable crash trigger apparatus of claim 1, wherein the method of judging if the vehicle satisfies the crash criterion by the real-time processing unit includes:
extracting the acceleration values in the directions of at least one axis measured by the electronic accelerometer module;
calculating the resultant acceleration value;
judging if the resultant acceleration value exceeds a threshold acceleration value;
calculating the resultant velocity variation; and
judging if the resultant velocity variation exceeds a minimum velocity variation.

6. The adjustable crash trigger apparatus of claim 5, wherein the resultant acceleration value is the square root of the sum of each of the acceleration values in respective axis squared.

7. The adjustable crash trigger apparatus of claim 5, wherein the resultant velocity variation is the square root of the sum of each of the velocity variations in respective axis squared.

8. The adjustable crash trigger apparatus of claim 5, wherein when the resultant acceleration value is smaller than the threshold acceleration value, re-extract the acceleration values in the directions of at least one axis for judgment.

9. The adjustable crash trigger apparatus of claim 5, wherein when the resultant velocity variation is smaller than the threshold acceleration value, re-extract the acceleration values in the directions of at least one axis for judgment.

10. The adjustable crash trigger apparatus of claim 1, wherein the trigger alarm signal is transmitted to an emergency transmitting device.

11. The adjustable crash trigger apparatus of claim 10, wherein the emergency transmitting device can be an Emergency Locator Transmitter (ELT).

12. The adjustable crash trigger apparatus of claim 1, wherein the power supply module can a rechargeable battery.

13. The adjustable crash trigger apparatus of claim 1, wherein the vehicle can be one of marine, ground, or flight vehicles.

14. The adjustable crash trigger apparatus of claim 1, wherein the microcontroller module further includes a self-test unit testing if the adjustable crash trigger apparatus operates normally.

15. The adjustable crash trigger apparatus of claim 14, wherein the self-test unit receives the signal transmitted by the emergency transmitting device for self-test.

16. The adjustable crash trigger apparatus of claim 14, wherein when the self-test unit detects failure in the adjustable crash trigger apparatus, an alarm signal is produced.

17. The adjustable crash trigger apparatus of claim 16, wherein the alarm signal is a sound or a light.

18. The adjustable crash trigger apparatus of claim 1, wherein the microcontroller module further includes a reset unit resetting the microcontroller module by receiving the signal transmitted by the emergency transmitting device.

19. An adjustable crash trigger method, comprising:
measuring acceleration values in the directions of at least one axis of a vehicle;
judging if the vehicle satisfies the crash criterion; and
transmitting a trigger alarm signal.

20. The adjustable crash trigger method of claim 19, wherein when the vehicle does not satisfy the crash criterion, re-measure acceleration values in the directions of at least one axis of the vehicle.

21. The adjustable crash trigger method of claim 20, wherein the method of judging if the vehicle satisfies the crash criterion includes:
extracting the acceleration values in the directions of at least one axis;
calculating the resultant acceleration value;
judging if the resultant acceleration value exceeds a threshold acceleration value;
calculating the resultant velocity variation; and
judging if the resultant velocity variation exceeds a minimum velocity variation.

22. The adjustable crash trigger method of claim 21, wherein when the resultant acceleration value is smaller than the threshold acceleration value, re-extract the acceleration values in the directions of at least one axis for judgment.

23. The adjustable crash trigger method of claim 21, wherein when the resultant velocity variation is smaller than the threshold acceleration value, re-extract the acceleration values in the directions of at least one axis for judgment.

24. The adjustable crash trigger method of claim 21, wherein the resultant acceleration value is the square root of the sum of each of the acceleration values in respective axis squared.

25. The adjustable crash trigger method of claim 21, wherein the resultant velocity variation is the square root of the sum of each of the velocity variations in respective axis squared.
